(19) United States
(12) Patent Application Publication
(10) Pub. No.: US 2026/0338147 A1
(43) Pub. Date: Oct. 29, 2026

(54) FUEL PUMP FOR DIRECT FUEL INJECTION FOR INTERNAL COMBUSTION ENGINES WITH A RETAINING WASHER

(71) Applicant: PHINIA DELPHI LUXEMBOURG SARL, Belvaux (LU)

(72) Inventors: Richard DUPONT, Tours (FR); Eric MINY, Chailles (FR)

(21) Appl. No.: 19/107,229

(22) PCT Filed: Jul. 28, 2023
(86) PCT No.: PCT/EP2023/071046

§ 371 Date: Feb. 27, 2025

(30) Foreign Application Priority Data
Sep. 8, 2022 (FR) FR2208963

(51) Int. Cl. F02M 59/44; F02M 59/10; F04B 19/04; F04B 53/14

(52) U.S. Cl. CPC F02M 59/44; F02M 59/10; F04B 19/04; F04B 53/14

(57) ABSTRACT

A fuel pump for direct fuel injection for internal combustion engines includes a pump body, a pumping chamber in which a piston is slidingly fitted, a spring bearing on the one hand on the pump body and on the other hand against an end of the piston projecting out of the pump body via a retaining washer and joining means between the retaining washer and the end of the piston, the retaining means including a circular groove at the end of the piston. The retaining means further includes an aperture made in the retaining washer allowing the end of the piston to pass into the aperture, and a notch in the retaining washer accommodated in the circular groove joined to the aperture by a slot which is narrower than the outer diameter of the piston at the end but wider than the diameter of the bottom of the groove.

### FIELD OF THE INVENTION

The invention relates a fuel pump for direct fuel injection for internal combustion engines with a retaining washer for the action of a spring on a pump piston. It also relates to the retaining washer and to a method for installing the washer.

### BACKGROUND OF THE INVENTION

Fuel systems in modern, petrol-fuelled internal combustion engines, in particular those for the automotive market, use direct petrol injection, with the fuel injectors being used to inject the fuel directly into the engine's combustion chambers. In such direct-injection systems, the fuel coming from the tank is supplied by a low-pressure fuel pump incorporated into the tank. This low-pressure pump is generally electric and feeds a high-pressure pump which typically comprises a pump piston which is mobile within a pump body. The pump piston is actuated by a camshaft of the internal combustion engine so as to raise the fuel pressure fuel in a pumping chamber of the pump body. The fuel under high pressure is then distributed to the injectors which control injection of the fuel directly into the engine's combustion chamber.

Document EP 3 715 619 A1 discloses an example of a pump of this type. An example is also reproduced in FIG. 1. The movement of the piston 101 in the pumping chamber 1050 is provided by the camshaft 102 against a spring 103 which tends to hold one end of piston 101 bearing against one cam of the camshaft 102. The spring is of the helicoidal compression type and bears on the one hand on a seat 104 fixed to the body 105 of the pump and on the other hand on a retaining washer 106 joined to the end of the piston 101 by joining means 107. The joining means comprise two conical half-rings 1071 engaged with an indentation 1072 at the end of the piston and a conical receptacle 1073 borne by the retaining washer 106 in which are accommodated the conical half-rings 1071. The gradient of the cone of the receptacle 1073 is oriented in such a manner that the action of the spring 103 on the retaining washer 106 is blocked by the conical half-rings 1071 wedged in the receptacle 1073.

Although these retaining means are effective, they have a number of drawbacks. It will in effect be noted that assembly operations are complex. This is because it is necessary to place the spring and the retaining washer around the piston and then compress the spring in order to free up enough space to introduce the conical half-rings. Compression of the spring can then be released, so that the retaining washer moves to trap the conical half-rings. It will likewise be noted that it may happen that just a single half-ring is set in place and that this fault may only be belatedly detected, leading to high intervention costs. Furthermore, the surfaces of the indentation, of the conical half-rings and of the receptacle are relatively precisely machined surfaces, resulting in high production costs.

### SUMMARY OF THE INVENTION

It is therefore an object of the invention to provide a fuel pump for direct fuel injection for internal combustion engines which is simple and reliable to construct and which minimises costs.

With these objects in view, the invention provides a fuel pump for the direct injection of fuel for internal combustion engines, the pump comprising a pump body, a pumping chamber in which a piston is slidingly fitted, a spring bearing on the one hand on the pump body and on the other hand against an end of the piston projecting out of the pump body via a retaining washer and joining means between the retaining washer and the end of the piston, the retaining means comprising a circular groove at the end of the piston, the retaining means further comprising an aperture made in the washer allowing the end of the piston to pass into the aperture, and a notch in the washer accommodated in the circular groove and joined to the aperture by a slot which is narrower than the outer diameter of the piston at the end but wider than the diameter of the bottom of the groove, the retaining washer comprising a seat on which the spring bears, the seat being annular in shape and located in a plane passing through the bulge or located beyond the end of the piston, the pump being characterised in that the retaining washer further comprises a guide crown which is substantially frustoconical in shape and extends along the spring from the seat to centre the spring on the retaining washer.

By eliminating two parts, these retaining means reduce the number of parts relative to the prior art. Furthermore, the retaining washer may be manufactured by a cold cutting and cold heading method, which makes it possible to reduce the number of machining operations. By providing an aperture, the washer can be introduced onto the end of the piston via the aperture and then inserted into the groove for it to be retained there. The integrity of the periphery of the washer on which the spring bears is maintained. There is no longer any risk of a part of the retaining means being forgotten. With the annular-shaped seat, the spring bears evenly on the entire periphery of the washer. Together with the guide crown, the washer has an omega-shaped cross-section. This ensures natural stability of the washer with the spring's centre of thrust offset from the washer's instantaneous centre of rotation on the piston by the groove. Furthermore, the guide crown makes it easy to introduce the washer onto the end of the spring while ensuring that the spring and retaining washer are permanently centred. In addition, providing the connection between the central part and the seat by way of a frustoconical crown makes it possible to optimise materials usage and to provide the lightest possible washer. Lightness of the washer is an important objective, as it is subjected to high levels of acceleration during pump operation. Reducing its mass makes it possible to reduce the effort required to set it in motion.

According to one improvement, the retaining means furthermore comprise an indentation on the washer around the notch in which is accommodated a bulge of the piston between the groove and the end of the piston, a neck at the outlet of the indentation into the slot being of a smaller width than a diameter of the bulge. This thus ensures that, as long as the washer is bearing against the indentation, it cannot disengage radially from the groove. This is because, during a radial movement, the neck comes into abutment against the bulge and thus stops the radial movement of the washer. Since the spring presses the washer to bear against the indentation, there is no risk of the washer being disassembled.

According to one constructive arrangement, the indentation has a depth of between 0.05 and 1 mm, preferably between 0.2 and 0.5 mm.

The indentation preferably has a depth of between 0.3 and 0.4 mm. These values provide a good compromise between effectiveness of washer retention in the groove and ease of insertion. The deeper the indentation, the better is retention ensured, but the trickier is insertion. Furthermore, the deeper the indentation, the thicker the washer needs to be, which makes it heavier and compromises dynamic pump operation.

According to one constructive arrangement, the washer is arranged in the groove with axial clearance, the clearance being greater than the depth of the indentation. This clearance allows the washer to be axially offset during insertion, so that the neck can pass beyond the groove during radial movement to reach the position in which, by axial movement, the bulge is accommodated in the indentation. After the assembly operation, this clearance is put to no further use, as the axial position of the washer is determined by the spring which holds the washer with the indentation in abutment against the bulge.

According to one constructive arrangement, the frustoconical crown has a cone angle between an axis of the cone and a generatrix of between 20° and 30°.

According to one constructive arrangement, the ratio of the diameter of the retaining washer to the thickness of the washer by the seat is between 10 and 20, preferably between 13 and 17. In this way, a good balance between lightness and robustness is obtained.

According to one constructive arrangement, the ratio of the diameter of the retaining washer to the diameter of the piston is between 3 and 5, preferably between 3.5 and 4.

According to one constructive arrangement, the ratio of the diameter of the piston to the diameter of the bottom of the circular slot is between 1.4 and 1.7, preferably between 1.5 and 1.6. In this way, a good balance between washer retention and piston strength is obtained.

The invention also provides a retaining washer intended for a pump as described above.

The invention also provides a method for assembling a pump as described above, characterised in that the piston is introduced into the chamber, the spring is placed around the piston, force is applied to the spring to compress it, the retaining washer is engaged with the end of the piston through the aperture, the retaining washer is shifted transversely to engage the groove through the slot and then the notch, and the spring is released so that it bears on the washer and the piston. These operations may be carried out manually, but will preferably be automated.

### BRIEF DESCRIPTION OF THE FIGURES

The invention will be better understood and other peculiarities and advantages will become apparent on reading the following description, the description making reference to the appended drawings, in which:

FIG 1 is a view of a prior art pump;

FIG. 2 is a perspective view and in axial section of part of a pump according to a first embodiment of the invention;

FIG. 3 is a side view of an assembled piston and retaining washer for the assembly of FIG. 2;

FIG. 4 is a perspective view from below of the assembly of FIG. 3;

FIG. 5 is a perspective view from below of the retaining washer in the assembly of FIG. 2;

FIG. 6 is an axial cross-sectional view of the washer of FIG. 5;

FIG. 7 is a view from below of the retaining washer of FIG. 5.

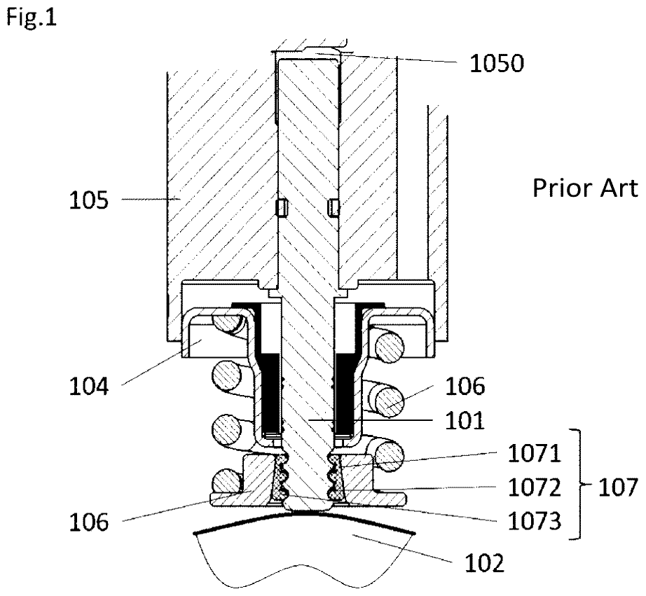

### DETAILED DESCRIPTION

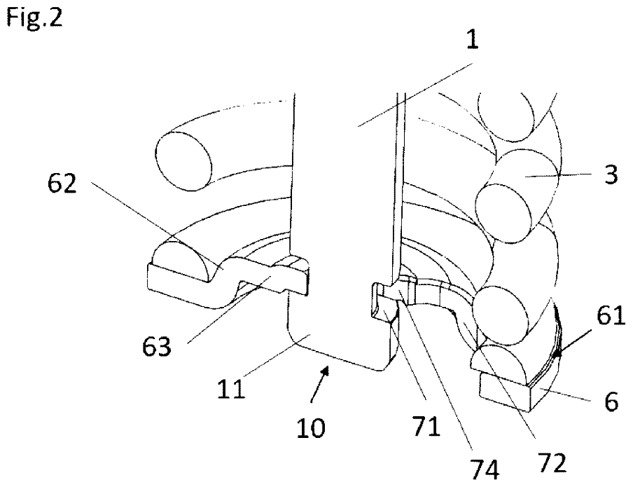

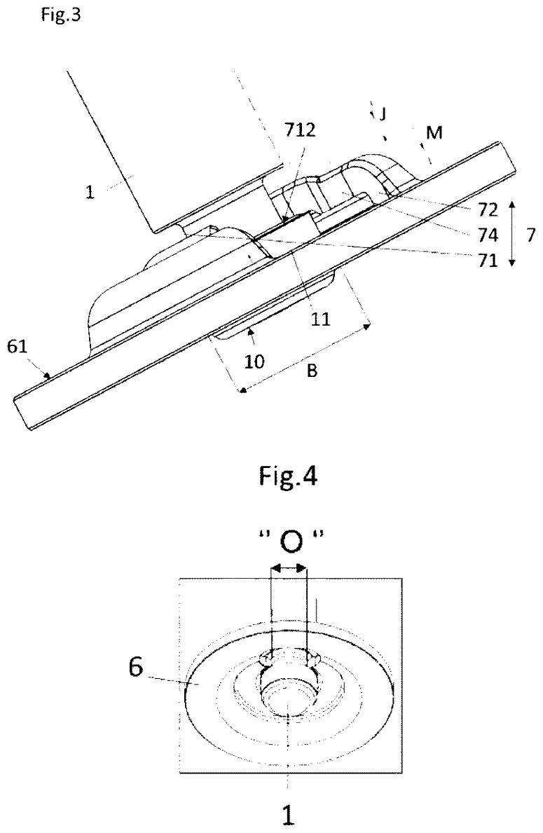

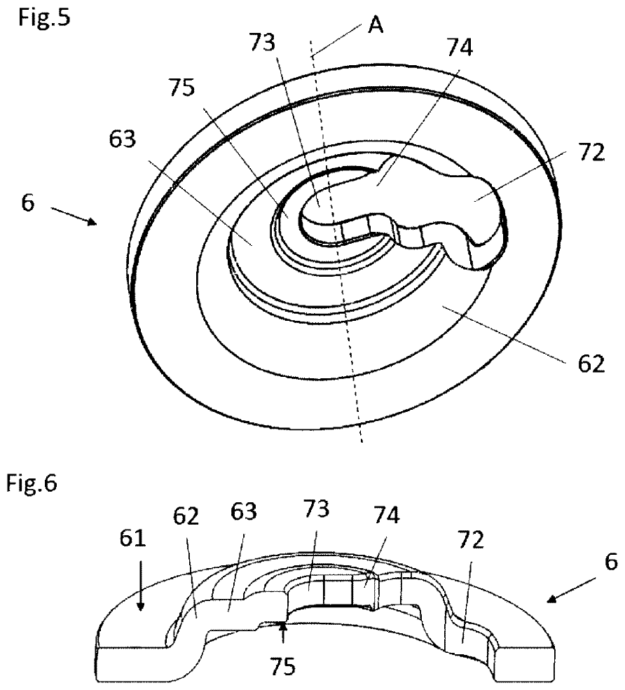

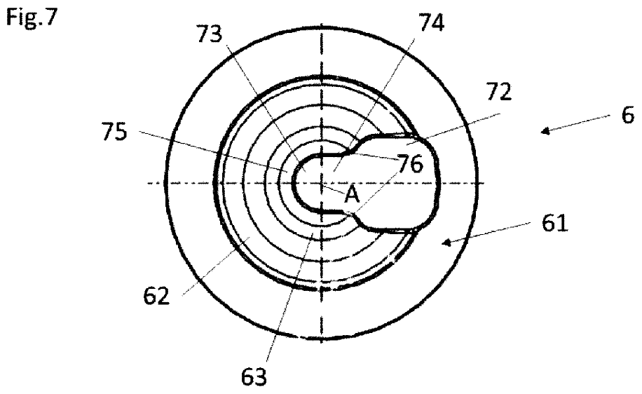

FIGS. 2 to 6 show part of a fuel pump for direct fuel injection for internal combustion engines according to one embodiment of the invention. The pump comprises a pump body, not shown, a pumping chamber, not shown, in which a piston 1 is slidingly fitted, a spring 3 bearing on the one hand on the pump body and on the other hand against an end 10 of the piston 1 projecting out of the pump body via a retaining washer 6. The retaining washer 6 comprises an annular-shaped seat 61 having a central axis A for receiving the spring 3. The retaining washer 6 further comprises a guide crown 62 likewise having as its axis the central axis A and extending along the spring 3 from the seat 61 to centre the spring 3 on the retaining washer 6, and in particular on the seat 61. The guide crown 62 is substantially frustoconical in shape with a cone angle between the central axis A and a generatrix of between 20° and 30°, for example of 23°. The crown 62 is extended by a ring 63 also having as its axis the central axis A and extending in a plane which is elevated relative to the plane of the seat 61.

Joining means 7 are provided between the retaining washer 6 and the end 10 of the piston 1. The joining means 7 comprise a circular groove 71 at the end 10 of the piston 1, in such a manner that the groove 71 defines a bulge 11 of the piston 1 between the groove 71 and the end 10 of the piston 1. The retaining means 7 furthermore comprise an aperture 72 made in the retaining washer 6 allowing the end 10 of the piston 1 to pass into the aperture 72, a notch 73 in the retaining washer 6 accommodated in the circular groove 71 joined to the aperture 72 by a slot 74 which is narrower than the outer diameter of the piston 1 at the end 10 but wider than the diameter of the bottom of the groove 71, and an indentation 75 on the retaining washer 6 around the notch 73 in which is accommodated the bulge 11. The indentation 75 is circular in shape. As can be seen in particular in FIG. 4, a neck 76 at the outlet of the indentation 75 into the slot 74 is of a smaller width, denoted “O”, than a diameter of the bulge 11, denoted “B”. It will also be noted that in the variant, the aperture 72 extends into the relief/curvature of the retaining washer 6, from the seat 61 (the inner periphery of which it eats into) through the crown 62 and the ring 63, up to the passage 74. Without compromising the mechanical strength of the retaining washer 6, this arrangement of the aperture makes it possible to create a larger aperture than if it were in a single plane.

An axial clearance indicated “J” remains between an upper face of the retaining washer 6 and a rear sidewall of the groove 71. This clearance is greater than the depth “M” of the indentation 75.

To assemble the pump, the piston 1 is introduced into the chamber, the spring 3 is placed around the piston 1, force is applied to the spring 3 to compress it and cause it to bear on the pump body, the retaining washer 6 is engaged with the end 10 of the piston 1 through the aperture 72, the retaining washer 6 is shifted transversely to engage the groove 71 through the slot 74 and then the notch 73, and the spring 3 is released so that it bears on the retaining washer 6 and the piston 1.

In operation, the indentation 75 of the retaining washer 6 is held bearing against the sidewall 712 of the groove 71 on the bulge 11 side.

The ratio of the diameter of the retaining washer to the thickness of the washer by the seat is for example 14.5.

The ratio of the diameter of the retaining washer to the diameter of the piston is for example 3.6.

The ratio of the diameter of the piston to the diameter of the bottom of the circular slot is for example 1.55.

1. Fuel pump for the direct injection of fuel for internal combustion engines, the fuel pump comprising: a pump body, a pumping chamber in which a piston is slidingly fitted, a spring bearing on the one hand on the pump body and on the other hand against an end of the piston projecting out of the pump body via a retaining washer and joining means between the retaining washer and the end of the piston, the retaining means comprising a circular groove at the end of the piston, the retaining means further comprising an aperture made in the retaining washer allowing the end of the piston to pass into the aperture, and a notch in the retaining washer accommodated in the circular groove and joined to the aperture by a slot which is narrower than the outer diameter of the piston at the end but wider than the diameter of the bottom of the groove, the retaining washer comprising a seat having a central axis on which the spring bears, the seat being annular in shape and located in a plane passing through the bulge or located beyond the end of the piston, wherein the retaining washer further comprises a guide crown which is substantially frustoconical in shape and extends along the spring from the seat to center the spring on the retaining washer.

2. Fuel pump according to claim 1, wherein the retaining means further comprises an indentation on the retaining washer around the notch in which is accommodated a bulge of the piston between the groove and the end of the piston, a neck at the outlet of the indentation into the slot being of a smaller width than a diameter of the bulge.

3. Fuel pump according to claim 2, wherein the indentation has a depth of between 0.05 and 1 mm.

4. Fuel pump according to claim 2, wherein the indentation has a depth of between 0.3 and 0.4 mm.

5. Fuel pump according to claim 2, wherein the washer is arranged in the groove with an axial clearance, the clearance being greater than a depth of the indentation.

6. Fuel pump according to claim 1, wherein the frustoconical crown has a cone angle between an axis of the cone and a generatrix of between 20° and 30°.

7. Fuel pump according to claim 1, wherein a ratio of a diameter of the retaining washer to a thickness of the washer by the seat is between 10 and 20.

8. Fuel pump according to claim 1, wherein a ratio of a diameter of the retaining washer to the a diameter of the piston is between 3 and 5.

9. Fuel pump according to claim 1, wherein a ratio of a diameter of the piston to a diameter of the a bottom of the circular slot is between 1.4 and 1.7.

10. Fuel pump according to one claim 1, wherein the aperture extends into the relief of the retaining washer, from the seat, the inner periphery of which it eats into, through the crown and a ring which prolongs the crown towards the central axis and extends in a plane which is elevated relative to the plane of the seat.

11. Retaining washer intended for a fuel pump according to claim 1.

12. Method for assembling a fuel pump according to claim 1, wherein the piston is introduced into the chamber, the spring is placed around the piston, force is applied to the spring to compress it, the retaining washer is engaged with the end of the piston through the aperture, the retaining washer is shifted transversely to engage the groove through the slot and then the notch, and the spring is released so that it bears on the retaining washer and the piston.
